(19) United States
(12) Patent Application Publication
(10) Pub. No.: US 2008/0080399 A1
(43) Pub. Date: Apr. 3, 2008

(54) ENHANCED NODE B CONFIGURATION WITH A UNIVERSAL INTEGRATED CIRCUIT CARD

(75) Inventors: Peter S. Wang, E. Setauket, NY (US); Ulises Olvera-Hernandez, Kirkland (CA); James M. Miller, Verona, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/866,612

(22) Filed: Oct. 3, 2007

Related U.S. Application Data
(60) Provisional application No. 60/827,934, filed on Oct. 3, 2006.

(51) Int. Cl. H04L 12/28

(52) U.S. Cl. 370/254

(57) ABSTRACT

A method for configuring an enhanced Node B (eNB) in a long term evolution (LTE) wireless communication network includes providing information to the eNB, wherein the eNB can perform a self-configuration process based on the provided information. An eNB for use in an LTE wireless communication network includes a universal integrated circuit card and a service control module. The universal integrated circuit card includes information that the eNB can use to perform a self-configuration process. The service control module is configured to receive the circuit card and read the information on the circuit card.

### CROSS REFERENCE TO RELATED APPLICATION

This application claims the benefit of U.S. Provisional Patent Application No. 60/827,934, filed on Oct. 3, 2006, which is incorporated by reference as if fully set forth herein.

### FIELD OF INVENTION

The present invention relates to wireless communications.

### BACKGROUND

The Third Generation Partnership Project (3GPP) has initiated the Long Term Evolution (LTE) program to bring new technology, a new network architecture, new configurations, and new applications and services to the wireless cellular network to provide improved spectral efficiency and faster user experiences. It has also raised the demand for a low maintenance LTE system in terms of network deployment and runtime service optimization.

FIG. 1 shows a current 3GPP universal terrestrial radio access network (UTRAN) architecture 100. The architecture includes a UTRAN layer 102 and a Core Network layer 104. The UTRAN layer 102 includes a radio access network or radio network system (RNS) 110, which consists of a radio network controller (RNC) 112 and one or more Node Bs 114. The configurations and operations of the deployed Node Bs 114 are controlled by the RNC 112 with explicit commands over an Iub link 116. The configurations and service upgrade of the Node Bs 114 depends on the RNC 112 and other cell engineering and planning efforts. No requirements are provided for self-configuration and optimization of the Node Bs 114 and accordingly, no means of self-configuration exists.

In the LTE network system, the architecture has been changed (referred to as an evolved UTRAN (E-UTRAN)), and the RNC node is eliminated. A different node, an enhanced Node B (eNB) performs the entire radio access network functionality for E-UTRAN and is linked directly with the Core Network and with other eNBs.

FIG. 2 shows an LTE E-UTRAN architecture 200. The architecture 200 includes an E-UTRAN layer 202 and an evolved packet core (EPC) layer 204. The E-UTRAN layer 202 includes a plurality of eNBs 210, which communicate with each other via an X2 interface 212. The EPC layer 204 includes a plurality of mobility management entities (MME)/user plane entities (UPE) 220. Each eNB 210 communicates with the MME/UPEs 220 via an S1 interface 222.

In the LTE E-UTRAN architecture 200, the eNBs 210 assume the RAN configuration, operation, and management control functions as well as the radio interface configurations and operations. The eNBs 210 interact directly with the LTE Core Network 204 and with neighboring eNBs 210 or other network nodes to directly handle the UE mobility management tasks.

Given the network and peer connections to the eNB and the demand for low network maintenance requirements, it would be advantageous to meet the LTE requirements with the benefit of low cost and high flexibility. More particularly, it would be beneficial to provide a method and apparatus to enable LTE E-UTRAN self-configuration and self-optimization.

### SUMMARY

A method for configuring an enhanced Node B (eNB) in a long term evolution (LTE) wireless communication network includes providing information to the eNB, wherein the eNB can perform a self-configuration process based on the provided information. An eNB for use in an LTE wireless communication network includes a universal integrated circuit card and a service control module. The universal integrated circuit card includes information that the eNB can use to perform a self-configuration process. The service control module is configured to receive the circuit card and read the information on the circuit card.

### BRIEF DESCRIPTION OF THE DRAWINGS

A more detailed understanding of the invention may be had from the following description, by way of example, and to be understood in conjunction with the accompanying drawings, wherein:

FIG. 1 shows an existing 3GPP UTRAN architecture;

FIG. 2 shows an LTE E-UTRAN architecture;

FIG. 3 is a diagram of a wireless communication system employing a UICC in an LTE eNB;

FIG. 4 is a block diagram of an eNB including a UICC device for self-configuration; and

FIG. 5 is a flow diagram of a method for self-configuration for an E-UTRAN/eNB.

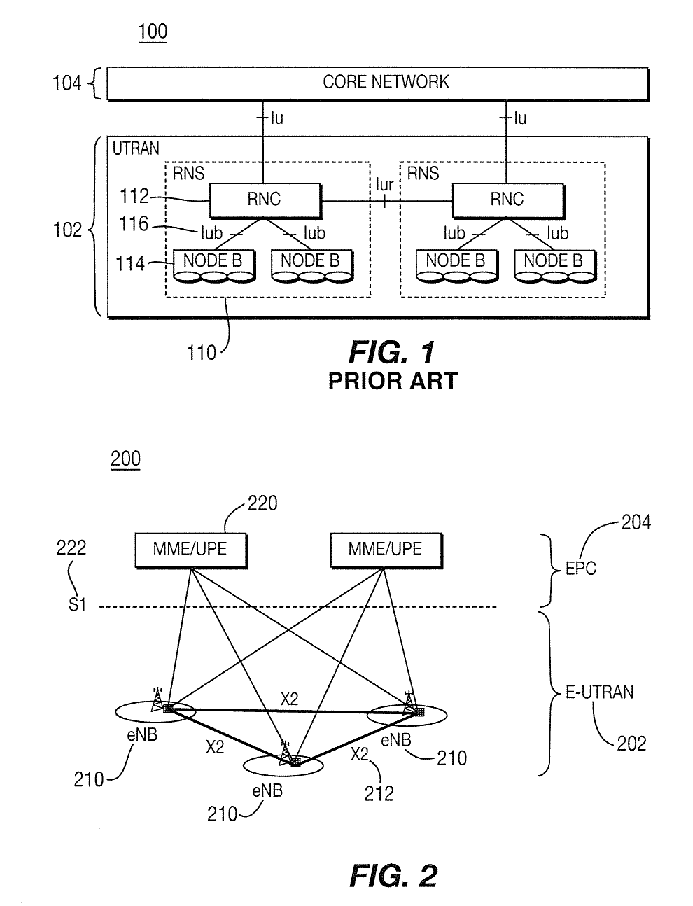

### DETAILED DESCRIPTION

Hereafter, the term “wireless transmit/receive unit (WTRU)” includes, but is not limited to, a user equipment, a mobile station, a fixed or mobile subscriber unit, a pager, or any other type of device capable of operating in a wireless environment. When referred to hereafter, the term “base station” includes, but is not limited to, a Node B, a site controller, an access point, or any other type of interfacing device in a wireless environment.

A self-configuration method for the LTE E-UTRAN/eNB with assistance from a UICC device as a component of the eNB in the LTE radio access network is disclosed herein. Currently, a UICC is used for static configuration for WTRUs. Given that the hardware structure/requirements are different for an eNB versus a WTRU, the UICC may not take the same form as it does in the current WTRU. Thus, the functionality of a UICC could be achieved using the same hardware as in a WTRU, but could also be achieved in a different manner such as a plug-in circuit board or other known ways for a smart card type devices. As used herein, the term “UICC” when used in reference to an eNB refers to any of these methods to implement the UICC functionality.

A goal is to provide for a minimum configuration effort or no configuration effort when an eNB (and the E-UTRAN) is deployed into the LTE network system. The LTE eNB deployed performs the self-configuration to certify and attach itself to the network and to associate with neighboring LTE or non-LTE cells, eNBs, or other base stations into a working order upon becoming linked to the LTE network and powered up. This concept is referred to as plug and play (PnP) capability for LTE E-UTRAN deployment.

In order to perform self-configuration, an eNB should have the following functionality:

1. The capability of having its own and related identities ready to be functional.

2. The security parameters and various algorithm functions to perform authentication with the network and with its peers.

3. The baseline system information to integrate with the newly acquired network information.

4. The ability to execute standard procedures and operator-specific procedures during the self-configuration process.

5. The ability to support runtime reconfiguration by the network or the operations and maintenance (O&M) center for subsequent activation. This means that dynamic configurations such as network ID/Cell ID mapping, security keys, and operational algorithms for self-configuration and optimization task upgrades can be downloaded and stored at the eNB to be executed upon activation triggering.

Accordingly, a portable device that can store information and execute functions is needed, such as a UICC smart card device in an eNB to fulfill the self-configuration and self-optimization requirements. A benefit of using a UICC is that OEMs and LTE vendors can concentrate on the standard and basic eNB functionalities, while letting the LTE network operator and service providers plan for the deployment and resource allocation with the configuration-specific parameters and algorithms.

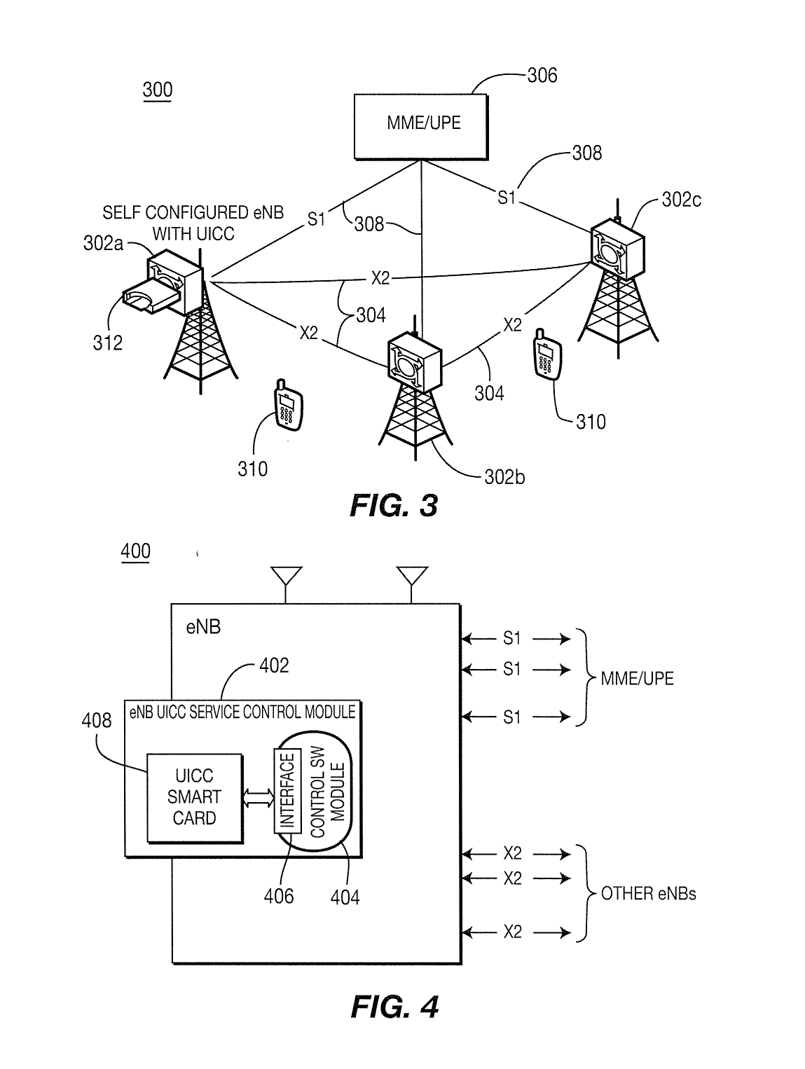

FIG. 3 is a diagram of a wireless communication system 300, including a plurality of eNBs 302a, 302b, 302c that communicate with each other via an X2 interface 304. An MME/UPE 306 communicates with the eNBs 302 over an S1 interface 308. A plurality of WTRUs 310 communicate with the eNBs 302. The eNB 302a is shown with a UICC 312. Given standardized hardware and software for the eNBs 302, the network operators and service providers are able to pre-configure the eNB 302a with input to the UICC 312 to define standardized behavior and operator-specific behavior to be performed by the eNB 302a during self-configuration and possibly during subsequent operations. The parameters and functionalities residing on the UICC 312 can be updated though the appropriate network interfaces or links to provide further eNB/E-UTRAN upgrading, reconfiguration, and restarting.

A UICC smart card device and its supporting interface, hardware (HW), and software (SW) at an LTE eNB is referred to herein as an “E-UTRAN Service Configuration Control Module” (ESCM). In one embodiment, the ESCM uses the same card format as a UMTS subscriber identity module (USIM) in a UMTS handset. Accordingly, the ESCM should have at least the following categories of static configuration and operating parameters at the pre-configuration phase set by the network operator:

1. The eNB ID.

2. The number of cells it creates and controls and the cell IDs.

3 The service operator's ID or home public land mobile network (PLMN) ID.

4. The radio parameters for the cell, such as frequency band, cell transmit and receive bandwidth value, antenna information, baseline cell common channel configurations, etc.

5. The surrounding eNB and/or base station information, baseline neighboring cell list, and cell admission threshold values.

6. Authentication and security parameters and algorithm modules.

7. The baseline LTE system information elements, to be integrated with other network parameters to form the system information blocks.

With the ESCM device, the OEM can be relieved of the duty for building the equipment with the service or network information. The service providers and network operators can input the necessary E-UTRAN identifications and specific operating algorithms to the UICC before deployment. At deployment, the operating parameters of the E-UTRAN and the eNB are available from the UICC and the procedures and algorithms on the UICC are executed to guide the E-UTRAN's self-configuration.

There is also a dynamic part of the ESCM content, which provides storage for runtime parameters such as temporary identities, runtime variables, and algorithm threshold values. The dynamic part of the ESCM content can be further modified or optimized once the eNB has joined the LTE service to the network. Some of the content may be saved statically as suitable values for the deployed environment. It is noted that both the static and the dynamic parts of the ESCM content can contain standardized and operator specific parameters and values.

Given that a UICC can serve as a module with pre-configuration significance, its usage facilitates the quick cloning or replication of an entire network for the deployment of LTE to a new market.

FIG. 4 is a block diagram of an eNB 400. The eNB 400 includes an eNB UICC service control module (or ESCM) 402, which includes a control SW module 404, an interface 406, and a device driver. A UICC smart card 408 is inserted into the service control module 402 where the UICC 408 communicates with the control SW module 404 via the interface 406 and the device driver.

The control SW module 404 connects the ESCM 402 with other eNB software controls and functions (not shown). The control SW module 404 performs the standardized steps of eNB self-configuration and other interface functions between the UICC 408 and the rest of the eNB functionalities. It is noted that one skilled in the art could implement the control SW module 404 as hardware or as a combination of hardware and software without altering the function of the module 404.

Upon UICC 408 activation and during self-configuration, the control SW module 404 reads out the parameters from the UICC 408, such as the primary operator's identity, to acquire and use the primary operator's SiC for IP address acquisition. The control SW module 404 then executes the eNB network authentication by invoking the authentication algorithm function modules in the UICC 408 to perform the security algorithm. The control SW module 404 then invokes other UICC function modules for network synchronization, attachment, eNB mutual trust establishment, association, etc.

The UICC 408 contains specific parameters, functional modules, and working parameter space accommodating regular as well as security and operator specific demands. The contents of the UICC 408 can be scrambled or otherwise encrypted to protected the contents. Another security option for the UICC 408 is that an unauthorized withdrawal of the UICC 408 from the ESCM 402 can cause an automatic destruction of the data on the UICC 408. A specific code sequence can be built into the ESCM 402 either as a software authentication sequence or as hardware through which the code sequence is downloaded over network connections once proper handshaking between the UICC 408 and the ESCM 402 has been completed. The coordination of the UICC 408 and the control SW module 404 fulfills the eNB self-configuration requirements.

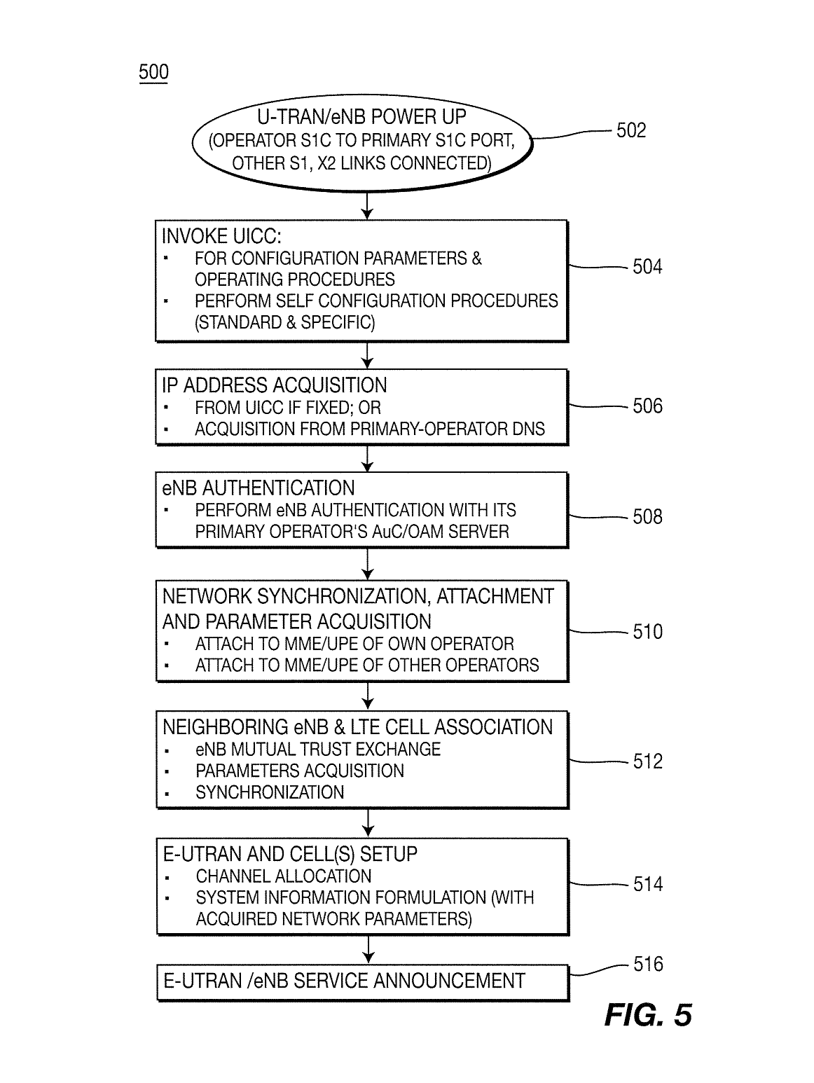

FIG. 5 is a flow diagram of a method 500 for self-configuration for an E-UTRAN/eNB. Utilizing the UICC, the parameters and procedures for performing the eNB's self-configuration tasks are available to fulfill the self-configuration requirements.

The method 500 begins with the E-UTRAN/eNB powering up (step 502). The powering up process includes connecting the operator's SIC interface to the primary S1C port of the eNB and connecting S1 links to available MME/UPEs and X2 links to available eNBs. Given the S1-flex and the fact that an eNB could be linked to more than one operator's access gateways (aGWs), there is a primary S1C port (or other identification) on the eNB to link the eNB with its own operator's aGW. As described herein, the primary operator is the network operator that deploys the particular eNB. This connection assists the process of eNB dynamic IP address acquisition and eNB authentication, since both of the actions are performed by the eNB with its operator's network. The primary S1C port helps the eNB identify its own operator's link to avoid a complicated operator identification process.

Alternately, a simple node resolution protocol can be employed that the eNB publishes an inquiry to all connected aGWs over S1Cs to prompt the aGWs to identify themselves with their network identities to the upcoming eNB.

Lightweight authentications between the self-configuring eNB and existing neighboring eNBs can be performed to guard against security fraud and provide ciphering key agreement and keys on the X2C traffic. This is the eNB mutual trust establishment.

After the powering up step is complete, the configuration parameters and operating procedures are loaded from the UICC to the eNB (step 504). The eNB performs self-configuration procedures, including any standard configuration procedures and any operator specific configuration procedures.

The eNB then performs IP address acquisition (step 506). The IP address is obtained from the UICC if the eNB's IP address is fixed or from the primary network operator's domain name server (DNS) if the IP address is dynamically assigned.

The eNB performs an authentication procedure with the authentication center (AuC)/operations and maintenance (OAM) server though its primary operator's aGW (step 508). The eNB also obtains, in the authentication procedure or through a subsequent procedure, the security parameters for eNB mutual trust exchange and the security parameters for the operation of WTRUs. The subsequent procedure may also retrieve parameter information for interacting with other operator's aGWs (that will be linked for LTE network sharing).

The eNB performs network synchronization, attachment, and parameter acquisition by attaching to the MME/UPE of the primary operator and the MME/UPEs of other operators, if available (step 510).

The eNB then associates to neighboring eNBs and LTE cells (step 512). The association procedure includes eNB mutual trust exchange, parameter acquisition, and synchronization. The eNB exchanges security credentials to establish the eNB mutual trust with the linked neighboring cells and to measure the neighboring LTE eNBs' radio transmission to synchronize either completely with them or with a recognized offset for radio transmission and reception.

Next, E-UTRAN and cell setup is performed, including channel allocation and system information formulation with acquired network parameters (step 514). The eNB then creates the synchronization channel (SCH), the broadcast channel (BCH), and other common channels of the cell(s), formats the system information from the baseline system information and the acquired network and neighboring eNB parameter information.

Lastly, the eNB performs an E-UTRAN/eNB service announcement, which includes putting up the SCH, the BCH, and other common channels and starting broadcast system information and monitoring uplink channel for possible WTRU accesses (step 516).

Although features and elements are described herein in particular combinations, each feature or element can be used alone without the other features and elements or in various combinations with or without other features and elements. The methods or flow charts described herein may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

The teachings described herein may be implemented in any type of wireless communication system, as desired. By way of example, the teachings described herein may be implemented in any type LTE system or any other type of wireless communication system. The teachings described herein may be applied in Radio Resource Management (RRM) and Radio Resource Controller (RRC), at the application layer, Physical Layer (Layer 1), eNB architecture, and Network Layer (Layer 3). The teachings described herein may also be implemented as software, or on an integrated circuit, such as an application specific integrated circuit (ASIC), multiple integrated circuits, logical programmable gate array (LPGA), multiple LPGAs, discrete components, or a combination of integrated circuit(s), LPGA(s), and discrete component(s). The teachings described herein may be applied in a base station, in the system, or at the network level.

What is claimed is:

1. A method for configuring an enhanced Node B (eNB) in a long term evolution (LTE) wireless communication network, comprising the step of:
providing information to the eNB, wherein the eNB can perform a self-configuration process based on the provided information.

2. The method according to claim 1, wherein the information is provided on a universal integrated circuit card.

3. The method according to claim 2, wherein the circuit card is a subscriber identity module.

4. The method according to claim 1, wherein the self-configuration process includes connecting the eNB to the network operator's access gateway.

5. The method according to claim 1, wherein the self-configuration process includes connecting the eNB to neighboring eNBs.

6. The method according to claim 1, wherein the self-configuration process includes performing a node resolution protocol to identify connected access gateways.

7. The method according to claim 1, wherein the self-configuration process includes acquiring an Internet Protocol address.

8. The method according to claim 7, wherein
the information is provided on a universal integrated circuit card; and
the Internet Protocol address is fixed and is obtained from the circuit card.

9. The method according to claim 7, wherein the Internet Protocol address is dynamically assigned and the eNB obtains the Internet Protocol address from the network operator's domain name server.

10. The method according to claim 1, wherein the self-configuration process includes performing an authentication procedure.

11. The method according to claim 10, wherein the authentication procedure is performed between the eNB and an authentication center on the network.

12. The method according to claim 10, wherein the authentication procedure is performed between the eNB and an operations and maintenance server on the network.

13. The method according to claim 10, wherein the authentication procedure includes obtaining security parameters for the eNB, the security parameters selected from the group consisting of parameters for an eNB mutual trust exchange procedure and parameters for operation between the eNB and a wireless transmit/receive unit.

14. The method according to claim 1, wherein the self-configuration process includes the steps of:
attaching to a mobility management entity/user plane entity of the network operator;
performing network synchronization; and
performing parameter acquisition.

15. The method according to claim 1, wherein the self-configuration process includes the steps of:
performing eNB mutual trust exchange with neighboring eNBs;
acquiring parameters;
synchronizing to the neighboring eNBs; and
associating the neighboring eNBs.

16. The method according to claim 15, wherein the synchronizing step includes determining an offset for radio transmission and reception.

17. The method according to claim 1, wherein the self-configuration process includes:
performing a cell setup procedure, including the steps of:
allocating channels, including a synchronization channel, a broadcast channel, and other common channels of the cell; and
formatting system information from baseline system information and acquired network and neighboring eNB parameter information.

18. The method according to claim 1, wherein the self-configuration process includes:
performing a service announcement procedure, including the steps of:
establishing common channels;
starting broadcast system information; and
monitoring an uplink channel.

19. The method according to claim 1, wherein the self-configuration process includes reconfiguring the eNB after the eNB has been powered up.

20. The method according to claim 19, wherein the reconfiguring step is triggered by the network.

21. The method according to claim 19, wherein the reconfiguring step is triggered by an operations and maintenance center on the network.

22. An enhanced Node B (eNB) for use in a long term evolution (LTE) wireless communication network, comprising:
a universal integrated circuit card, including information that the eNB can use to perform a self-configuration process; and
a service control module configured to receive said circuit card and read the information on said circuit card.

23. The eNB according to claim 22, wherein said service control module includes:
a control module configured to communicate with said service control module and other components in the eNB; and
an interface configured to communicate with said circuit card and said control module.

24. The eNB according to claim 23, wherein said control module is configured to perform the self-configuration process.

25. The eNB according to claim 22, wherein said circuit card includes information selected from the group consisting of: operating parameters of the eNB, functional modules for the eNB, and working parameter space.
